(19) United States
(12) Patent Application Publication
(10) Pub. No.: US 2010/0330383 A1
(43) Pub. Date: Dec. 30, 2010

(54) COMPOSITE GEL-BASED MATERIALS

(75) Inventors: Michael J. D. Nugent, County Westmeath (IE); Clement L. Higginbotham, County Westmeath (IE)

Correspondence Address: GREENBLUM & BERNSTEIN, P.L.C., 1950 ROLAND CLARKE PLACE, RESTON, VA, 20191, US

(73) Assignee: ATHLONE INSTITUTE OF TECHNOLOGY, County Westmeath (IE)

(21) Appl. No.: 12/918,519

(22) PCT Filed: Feb. 27, 2008
(86) PCT No.: PCT/EP08/52387

§ 371 Date: Aug. 20, 2010

(51) Int. Cl. B32B 27/08; C08L 29/04

(52) U.S. Cl. 428/520; 523/105

(57) ABSTRACT

A process for forming acomposite article composed of a gel with a support layer. The composite is formed by a gel-forming solution comprising of a polymeric material and a solvent, this gel-forming solution adsorbs onto a support layer. The formation process creates a gel andan adhesive bond between the gel and the support layer. The support layer is at least partially soluble in the solvent and the gel is attached to the support layer by freezing to form the gel on the support layer after a part of the support layer is solubilised by the solvent. The gel may be a hydrogel gel. The solvent may be water. The gel and the layer are physically interlocked. A composite is also described and has many end-use application including active agent delivery, dressings and coatings and in medical devices. Chemical cross-linking and additional adhesive are not required.

### FIELD

The present invention relates to gels such as hydrogels. In particular the present invention relates to novel composite articles that comprise a gel such as a hydrogel, processes for making those articles and to devices incorporating the composites. Of particular interest within the present invention are composites based on solvated, for example hydrated, gels such as solvated and in particular hydrated hydrogels.

### DISCUSSION OF RELATED ART

Gels are a hybrid of liquid and solid characteristics and show complex physical and mechanical behaviour. Specific types of gels are hydrogels and xerogels. A xerogel is a solid formed from a gel by drying with unhindered shrinkage while a hydrogel is a specific type of gel which may be described as a three dimensional, hydrophilic, polymeric network capable of imbibing large amounts of water or other fluids to form a soft and elastic material that maintains its three-dimensional structure or network. Many types of gels are known. Gels of interest in the present invention are those in which absorbed solvent can comprise at least 40% by weight such as at least 50% by weight such as at least 55%, 60% or 70% by weight. Typically gels of interest in the present invention will include over 80% and often times over 90% by weight of fluid.

Certain gels, and in particular hydrogels, have a hydrophilic character due to water-soluble groups such as OH, COOH and CONH₂, however the gel itself is insoluble because of the three-dimensional polymeric network. Hydrogels swell to a greater or lesser extent in water depending on the hydrophilic power of the side groups. Of particular interest are gels such as hydrogels of which at least 40% by weight is absorbed water or aqueous solution. Hydrogels have an insoluble network of polymer chains and absorb water by capillary and osmotic effects.

The swelling kinetics of hydrogels can be classified as diffusion-controlled (Fickian) and relaxation-controlled (non-Fickian) swelling. When water diffusion into the hydrogel occurs much faster than the relaxation of the polymer chains, the swelling kinetics is diffusion-controlled.

Various methods of preparing gels such as hydrogels have been utilised. The most common technique is to utilise free-radical polymerisation of vinyl monomers. Also, hydrogel laminates have been formed, by casting onto an adhesive-coated substrate an aqueous solution of hydrophilic polymer. The adhesive is required to effect bonding.

A problem associated with gels that possess good swelling properties is a rather low mechanical strength. Increasing the cross-linking density within a gel is thought to enhance the mechanical properties but decrease the swelling capacity. Non-volatile additives are thought to change and potentially enhance the mechanical strength. This approach has been used for polyvinyl alcohol (PVA) hydrogels created by freeze/thawing, in order to obtain wound dressing with enhanced properties.

Freeze/thaw processing has been used to form hydrogels such as those based on polyvinyl alcohol (PVA). These hydrogels are prepared by exposing aqueous PVA solutions to repeated cycles of freezing and thawing. This results in the formation of crystallites which renders the material insoluble in water.

In the freeze/thaw process, components such as NaCl may be used to impart a desired porosity to the gel. Other materials which have been added included sodium hydroxide and hydrochloric acid. These additives were found to provide PVA gels with differing physical properties. These properties included the amounts of bioactive agent that may be loaded within the gel.

One of the issues that has arisen in the formation of hydrogels has been their physical characteristics which are not conducive to ease of handling. Generally speaking, hydrogels are not directly applicable in their various end-use applications. Such applications include controlled active agent delivery such as drug delivery, coatings for pharmaceuticals, dissolution and binding agents in tablets, coating of medical devices and in various topical applications for example on the skin for treating cuts or wounds such as burns. For example, even though hydrogels form a good delivery system for pharmaceutical ingredients, it is difficult to provide a form of the hydrogel that can be easily applied and that will stay in a desired position.

### SUMMARY OF THE INVENTION

The present invention provides a composite article comprising:

(i) gel having absorbed solvent therein;

(ii) a support layer attached to the gel,

the composite article having being formed by providing a gel-forming solution comprising a polymeric material and a solvent; and attaching the gel to the support layer by forming the gel on the support layer after a part of the support layer is solubilised by the solvent. Such composites of the invention are suitable for use in biomedical and pharmaceutical applications.

In one arrangement the support layer is solubilised at an elevated temperature. This is a simple yet convenient construction which is easily formed with enhanced physical interconnection and good biocompatibility. The solubilisation of the support layer may be halted by sufficient cooling such as by freezing.

Desirably the gel is a hydrogel though any gel that can absorb large amounts of an appropriate solvent is suitable. Biocompatibility for hydrogels is good and water may be employed as a solvent which removes the need to utilise other materials which may cause irritation etc. In one arrangement the gel is based on polyvinyl alcohol. Additionally or alternatively the support layer may comprise polyvinyl alcohol. To enhance the properties of the support layer it may be desirable to include an additional material such as polyacrylic acid.

The composite may take any desired form and may form part of any article for application to the body including to the eyes, such as contact lenses.

The composite of the invention may further comprise any desirable active agent or combination of active agents. Any suitable active agent may be employed. The active agent may be in the gel or in the support layer or both. If desired different active agents may be employed in each. Furthermore it will be appreciated that various combinations of gels and/or support layers can be utilised for example in a layer structure.

The invention also relates to a process for forming a composite article comprising the steps of:
providing a gel-forming solution comprising a polymeric material and a solvent; providing a support layer for the gel, the support layer being at least partially soluble in the solvent; and

attaching the gel to the support layer by forming the gel on the support layer after a part of the support layer is solubilised by the solvent. The process forms a composite article composed of a gel with a support layer. The composite is formed by a gel-forming solution comprising of a polymeric material and a solvent, this gel-forming solution adsorbs onto a support layer. The formation process creates a gel and an adhesive bond between the gel and the support layer. The support layer being at least partially soluble in the solvent and attaching the gel to the support layer by forming the gel on the support layer after a part of the support layer is solubilised by the solvent.

The invention also relates to an assembly comprising a substrate having applied thereto a composite article wherein the composite article comprises:
a gel having absorbed solvent therein; and
a support layer attached to the gel, the composite article having being formed by providing a gel-forming solution comprising a polymeric material and a solvent;
and attaching the gel to the support layer by forming the gel on the support layer after a part of the support layer is solubilised by the solvent.

It will be appreciated that the assembly of the invention can take any suitable form, for medical application. The composite may be passive or bioactive and/or form part of a passive or bioactive device including a medical device as defined by USA FDA Regulations. In general the composite of the invention can act as a biomaterial with a passive or active function. The applications are many and include joint replacements, fixing plates, artificial tissues including muscle, skin, ligaments and tendons including repair devices therefor, prosthetic devices including cochlear replacements, implants including dental implants for tooth fixation, valves, and contact lenses.

In particular the substrate may be a flexible material and the assembly can form a medical dressing. In such construction the gel can be applied to and held to the body in a convenient form. This includes cut and wound bandages and plasters. Active agents can thus be administered by such dressings if required.

The composite can be applied to a medical device, particularly devices of the type to be introduced into the body or a device implanted in the body, including catheters, stents, cannulae, valves and the like. The composite can form a coating for the medical device. The composite can be created (in-situ) on any desired substrate including a medical device. The support layer can be employed to secure the composite to the device. If the substrate already includes a material which may form a support layer then the composite can be applied to the substrate by partial dissolution of the appropriate part of the substrate and application of the gel as described.

The present inventors exemplify their invention by providing a composite (PVA-NaOH hydrogel/PVA PAA layer or film) TH (theophylline) drug delivery system, which exhibits Fickian diffusion. Diffusion control potential can be added by selection of the support layer. Biomedical applications of such systems are biomedical membranes or coatings such as may be applied to in-dwelling medical devices or wound healing devices. A detailed characterization of the thermal, microstructure properties of the composite, as well as a drug release study is set out below.

Gels can be classified as either physically or chemically cross-linked based on the nature of the bonds in the three-dimensional networks. Chemical gels may be defined as three-dimensional molecular networks formed by the introduction of primary covalent cross-links or ‘clusters’, that are dispersed within the gel/hydrogel. These types of gels will not dissolve in water or other organic solvents but instead will swell in an aqueous solution. Chemical cross-linking imparts good mechanical strength and porosity. However, chemically cross-linked gels such as hydrogels contain cross-linking agents and by-products that can render them unsuitable for applications where biocompatibility is required. This is because even if action is taken to remove such agents such as by repeated washing there will still be undesirable residual material that causes issues such as irritation at the site in question or indeed materials may leach into the body causes problems in surrounding tissue.

Physical gels consist of hydrophilic polymer phases connected by highly ordered aggregates of chain segments. This aggregation of individual chains into clusters, may occur through either helix formation, secondary molecular forces or crystallisation. The three-dimensional mesh that is formed, gives rise to the gel properties. Unlike chemically bonded gels, these gels may eventually dissolve in water or solvents (for example at elevated temperatures) as there are no strong covalent bonds, only weak secondary bonds and inter molecular forces.

The gels of the present invention are physical gels. In particular the physical attachment of gel to the support layer is by physical interaction. Thus in the present invention there is no requirement for additional (chemical) materials to effect cross-linking etc. so the risk of reduced biocompatibility is removed. Furthermore only one freeze thaw action may be required to obtain a suitable gel. This means there is no requirement for chemical modification or chemical adhesives to bond the hydrogel and the layer together. Furthermore there is no requirement for a cross-linking agent to crosslink the hydrogel.

Gels and in particular hydrogels, may be composed of a polymeric matrix which may comprise homopolymers, copolymers or blends of different polymers. Gels such as hydrogels may be prepared from synthetic polymers, naturally occurring polymers or combinations thereof. Gels such as hydrogels may be formed by various techniques; with the most common synthetic route being the free radical polymerisation of vinyl monomers. Suitable materials for forming the polymeric matrix within the gel also include those comprising hydrophilic functional groups such as carboxylic (—COOH), amide (—CONH₂), and sulfonyl (—SO₃H) groups.

The support layer is desirably water-insoluble, but swells in aqueous solution. Exemplary synthetic polymers include hydrophilic synthetic polymers such as polyvinyl alcohol, polyethylene oxide, polyhydroxyethylmethacrylate, polyvinylpyrrolidone, polyvinylidone, polyethyleneglycol, and combinations and blends thereof. Other gel materials such as polyalcohols such as those based on glycerin, ethyleneglycol, propyleneglycol, 1-3-butyleneglycol, hexylene glycol, sorbitol, mannitol, polyethyleneglycol and combinations thereof. Polyvinylpyrrolidone or polyaniline is also suitable for forming the gel component of a composite of the present invention when combined with another material such as PVA. Naturally occurring polymers useful in the preparation of hydrogels may be found among carrageenan, gelatin, agar, alginate, collagen and chitosan and combinations and blends thereof. Natural polymers such as carrageenan, are non-toxic. They may have additional desirable properties such as acting as an emollient.

The polymeric material is generally insoluble in a target solvent, often times water, due to the presence of chemical cross-links or physical cross-links. The use of PVA, PAA and different solvents results in the formation of a multi-component system or polymer blend. Polymer blends are extremely useful for commercial and biomedical applications because different properties are relatively easily obtained, by the judicious combination of compatible components. Polymer blends have many diverse uses in thermoplastics, conducting materials, hybrid inorganic-organic polymer alloys, and in light emitting diodes. Hybrid hydrogels may also be employed.

Polyvinyl alcohol, a hydrophilic polymer suitable as a biomaterial, has excellent mechanical and thermal strength and can be cross-linked physically, for example, through several rounds of freezing and thawing. Having these physical properties, polyvinyl alcohol is particularly useful to form the gel or hydrogel component of a composite of the present invention and in particular to form good physical bonding with the support layer without requiring chemical cross-linking.

The close resemblance of materials such as PVA gels to human soft tissue including high water content, a rubbery and elastic nature has made them a material of choice for many biomedical applications. PVA gels are ideal candidates for the design of a sustained release vehicle for biomedical and drug delivery applications due to desirable properties. These properties include good processability, reasonable strength, and long-term temperature and pH stability, together with low toxicity, minimal cell and protein adhesion.

One of the interesting features of the present invention is that gels with different properties were possible to prepare, by simply varying the polymer ratios and by changing the solvent and by varying the support layer. Also PVA is thermoresponsive and dissolves totally as the temp. is increased from 45° C. to 85° C.

Certain gels such as hydrogels react to differences in the environment with properties such as volume or viscosity changing in response to pH, temperature or mechanical stress. Such reactions can be taken into account when the end-use application of the composite of the invention is known. For example the incorporation of PAA makes the hydrogel pH sensitive which allows for further functionality such as for oral delivery of an active agent.

Gels and in particular hydrogels are biocompatible, and as they may be stimuli responsive materials this can be harnessed to increase the versatility of applications such as in invasive medical devices and in targeted delivery of drugs.

Suitable solvents including mixtures thereof may be employed. Suitable solvents include water, ethylene glycol, dimethyl sulfoxide (DMSO), N-methylpyrrolidone, glycerine, propylene glycol and ethanol and mixtures of these solvents. For example for PVA, water, ethylene glycol, dimethyl sulfoxide (DMSO), and N-methylpyrrolidone are suitable solvents.

Desirably the solvent is water which may increase biocompatibility. It is desirable that the polymer matrix forming the gel structure is water insoluble at room or body temperatures. It is also desirable that the polymer material forming the support layer is also water soluble but at elevated temperatures exceeding room and body temperatures. Desirably in such an embodiment the support layer is solubilised by water.

The composite of the present invention can be used in many applications, such as for external application to the body. For wound healing and skin treatment, including cuts and burns it is desirable that the solvent is aqueous. This applies also for other applications such as in ophthalmic and internal applications, for example contact lenses and to form a coating on a medical device that is inserted into the body or implanted in the body, intervertebrate disc nuclei; artificial articular cartilage; contact lenses; matrices for cell immobilisation; as a wound covering as a denture base and in the controlled release of drugs and growth factors.

For example at least 60% (by weight) of the gel part of the composite may comprise water or an aqueous solution.

Maintaining a moist environment facilitates biocompatibility for example in cutaneous and percutaneous application such as in the wound healing process, the treatment of the skin such as in the treatment of skin disorders, and for topical or transdermal delivery of an active agent. The beneficial effects of a moist versus a dry environment can include one or more of: prevention of tissue degradation and cell death, accelerated angiogenesis, increased breakdown of dead tissue and fibrin, i.e., pericapillary fibrin cuffs, and potentiating the interaction of growth factors with their target cells. In addition, pain is significantly reduced when wounds are covered with an occlusive dressing. Irritation is also less likely to occur. Retaining desirable moisture, for example in treatment of wounds, can be achieved without any increase in the risk of infection as compared to more conventional approaches. Hydrocolloid occlusive dressings are useful in maintaining a moist environment and are useful in facilitating wound healing.

The support layer of the composite will be arranged with the gel so that the support layer imparts stability to the gel so that the composite has sufficient structural integrity. This is important for storage/handling and to maintain the function of the composite over time.

The support layer of the composite may be constructed of any suitable material including polymeric materials. Examples include: polymers based on ethylene vinylacetate (EVA); ethylene vinylalcohol (EVOH), polyethylene such as low density polyethylene (LDPE), polyurethane, poly(vinyl chloride), poly(vinylidene dichloride), poly(vinylidene fluoride), poly(ethylene terephthalate), polymers and copolymers from acrylonitrile, aromatic polyamides, polyethylene naphthalenate, polyvinyl alcohol) or ethylene-vinyl-alcohol copolymers or combinations or blends thereof. The support layer will impart physical strength to the overall composite and in particular to the gel component thereof. In general then the support layer will be stronger than the gel allowing for more robust handling than with the gel alone. The support layer may be of any desired thickness for example from about 0.001 mm to about 10 mm. A thickness of 0.05 mm such as with a PVA layer leads to a very strong connection between the coating and the gel. However increasing and decreasing this thickness is possible depending on the mechanical structure of the support layer. Furthermore by adjusting the amount of hydrophilicity of the support layer, the degree of swelling can be controlled. Additionally this layer (film) can adhere to a further article such as a layer or substrate.

The support layer may support part of the gel, for example one side of the gel mass. In one arrangement the support layer may encompass the entire gel body.

When used in a coating application such as for coating a medical device for insertion or implantation into the body, the support layer may be of a thickness from about 0.001 mm to about 1 mm.

In one embodiment the composite is formed by freezing an aqueous solution of PVA/NaOH onto a PVA/PAA support layer. The layer and hydrogel so constructed formed a strong interface and demonstrated greater physical strength than the hydrogel alone. The support layer may be of a type which prevents loss of solvent from the gel. For example it may function as a moisture barrier. Alternatively or additionally, particularly for external application to a body, it may be desirable for the support layer to be air permeable for example to allow breathing of the skin.

In certain applications it is desirable that the support layer is air-permeable. In other applications it may be desirably that the composite is provided with an air (oxygen) barrier layer. The support layer may be selected to be sufficiently impermeable and/or may be further coated or laminated with an oxygen barrier layer. The oxygen barrier layer or coating is preferably a polymer or copolymer of vinyl alcohol and may be selected from poly(vinyl chloride), poly(vinylidene dichloride), poly(vinylidene fluoride), poly(ethylene terephthalate), polymers and copolymers from acrylonitrile, aromatic polyamides, polyethylene naphthalenate, polyvinyl alcohol) and preferably ethylene-vinyl-alcohol copolymers and combinations and blends thereof.

The support layer can also generally act as an effective barrier to contamination of the gel material, such as by external contaminants such as microbial material.

Active agents may be incorporated into the gel include pharmaceutically active agents and naturally occurring substances such as extracts for example plant extracts. Hydrogen peroxide may also be provided as an active agent. It is useful as an oxygenation material. This can be useful in wound healing.

A composite of the present invention is suitable for use as an effective delivery system for active agents of any type such as pharmaceutically active agents. Active agents are any materials that it may be desired to impart to the body by external or internal application. One aspect of a composite of the present invention is use as a sustained release system for an active agent. The active agent such as a drug should be maintained at a desired drug concentration while minimising any toxic side effects. It will be appreciated that by varying parameters and components of a composite of the present invention that a given release profile can be achieved. One aspect of the present invention can thus be considered to relate to a novel composite active ingredient delivery system. For example active pharmaceutical agents that may be added are proteins, painkillers, antibiotics, hormones and bronchial agents.

Extensive analysis of the preparation of PVA gels by freezing and thawing techniques has shown that several parameters significantly alter the overall structure, morphology and stability of the resulting materials. PVA can be manipulated to control properties such as the overall water content, mechanical strength, adhesive characteristics, and diffusive properties. An interesting approach to developing such gels for various biomedical and pharmaceutical applications involves investigating more than one material with optimal characteristics. By utilising the properties of different materials, a layered structure may be designed optimising characteristics for example for a desired API (Active Pharmaceutical Ingredient) release rate or profile.

The composite approach has been demonstrated by the present inventors whereby a PVA/PAA film (support layer) was incorporated into PVA/NaOH/H₂O hydrogels and the release of drugs showed a Fickian diffusion pattern over a relatively short period of time. This approach has potential as either a coating system or a stand-alone topical formulation.

A support layer comprising certain materials such as PAA may be pH sensitive. It is desirable for certain applications to include pH sensitive materials. For example the addition of an alkaline material such as NaOH can lead to an alkaline hydrogel. Addition of a low pH material can be employed to produce a pH responsive gel.

To achieve sustained release, which is independent of the drug molecular weight, active agents may be entrapped in a second phase, which is subsequently incorporated into composite. Furthermore the active agent may be incorporated into the support layer. For example an API may be incorporated into a PVA/PAA layer.

The freeze/thaw process may be repeated (for example between from 2 to 5 freeze/thaw cycles in total) if desired to introduce greater mechanical strength into the gel component. Desirably freezing is effected by exposure to a cooling fluid such as liquid nitrogen. This allows for rapid termination of the partial dissolution process. Generally the cooling fluid may be at a low temperature for example −10° C. or below, such as −20° C. or below; e.g. −30° C. or below. Typically about −40° C. is desirable though temperatures as low as −100° C. may be employed. Such temperatures assist in the formation of cross-links. When thawing it is desirable to allow the material to return to room temperature. Temperatures in the range 10 to 25° C. are desirable when thawing.

It will be appreciated that in a process of the invention there are number of processes which overlap in time to form the desired composite. Those include gel formation, partial layer dissolution and attachment of the gel to the layer (by physical interlocking) as these processes proceed. The gel can thus be considered to be formed in-situ. The in-situ formation is contemporaneous with the attachment to form the composite.

Materials to prevent infection may also be incorporated into the composite including antimicrobial materials. Examples include antibacterial, antiviral and antifungal agents.

The materials, and in particular a composite of the present invention, may be exposed to an amount of irradiation sufficient to sterilise. This may be conducted while the composite is held within a hermetically sealed pack.

### BRIEF DESCRIPTION OF THE DRAWINGS

FIG. 1: Image of composite with layer on the upper surface (hydrogel underside).

FIG. 2: Composite with hydrogel on the upper surface (layer underside).

FIG. 3: Composite interface between layer and gel.

FIG. 4: Differential scanning thermograms of dried samples of PVA/NaOH and PVA.

FIG. 5: Differential scanning thermograms of dried samples of PVA/NaOH/TH and PVA/TH and a sample of TH.

FIG. 6: Dried sample of PVA/Theophylline: topography pixel image and thermal conductivity image with corresponding intensity histograms.

FIG. 7: Dried sample of PVA: topography pixel image and thermal conductivity image with corresponding intensity histograms.

FIG. 8: Dried sample of PVA/NaOH: topography pixel image and thermal conductivity image with corresponding intensity histograms.

FIG. 9: Dried sample of PVA with TH: Micro MDTA endotherms.

FIG. 10: Dried sample of PVA without TH: Micro MDTA endotherms.

FIG. 11: Dried sample of PVA/NaOH without TH: Micro MDTA endotherms.

FIG. 12: Drug release profiles from PVA/NaOH/H₂O hydrogels in a phosphate buffer of pH 7.2 at 37° C.

FIG. 13: Drug release profiles from PVA/H₂O hydrogels in a phosphate buffer of pH 7.2 at 37° C.

### DETAILED DESCRIPTION

Furthermore, a detailed characterisation of the thermal, micro-structure and hydration properties of the composite, as well as a drug release study was undertaken. The resultant samples were characterised using optical microscopy, modulated differential scanning calorimetry (MDSC) and dissolution testing. The microstructure of the gels was examined using micro-thermal analysis (μTA).

### Materials and Methods

### Preparation of Samples

The preparation of the composite consists of casting an aqueous solution onto a layer, which is then subsequently frozen.

### Preparation of Gel Component

Poly (vinyl alcohol) used in this study was supplied by Aldrich and had a weight average molecular weight of 146,000-186,000 and a saponification value of 98-99%. TH was supplied by Aldrich with a molecular weight of 180.2 and a melting point of between 270° C. and 274° C.

Solutions were prepared by mixing polymer powder (1 g) with distilled water (40 mls) and 0.025M NaOH and 0.3 g of TH. Dissolution was achieved by heating the mixture to 80° C. for 90 minutes, while slowly stirring. When solids were no longer apparent and the mixture was clear, the beaker containing the solution was placed in an ultra sonic bath at 70° C. for 5 minutes to remove all bubbles.

### Preparation of Film (Support Layer) Component

PAA with a weight average molecular weight 3,000,000 was supplied by Aldrich. Solutions were prepared by mixing 66% PVA and 34% PAA in 300 ml of distilled water. Dissolution was achieved by heating to 80° C., while slowly stirring for about 90 minutes. When the polymers were no longer apparent the solution was placed in an ultra sonic bath at 70° C. for 5 minutes to remove all bubbles. The solution was then cast onto a Teflon coated glass basin and left in an oven at 80° C. for 24 hours.

### Preparation of Composite.

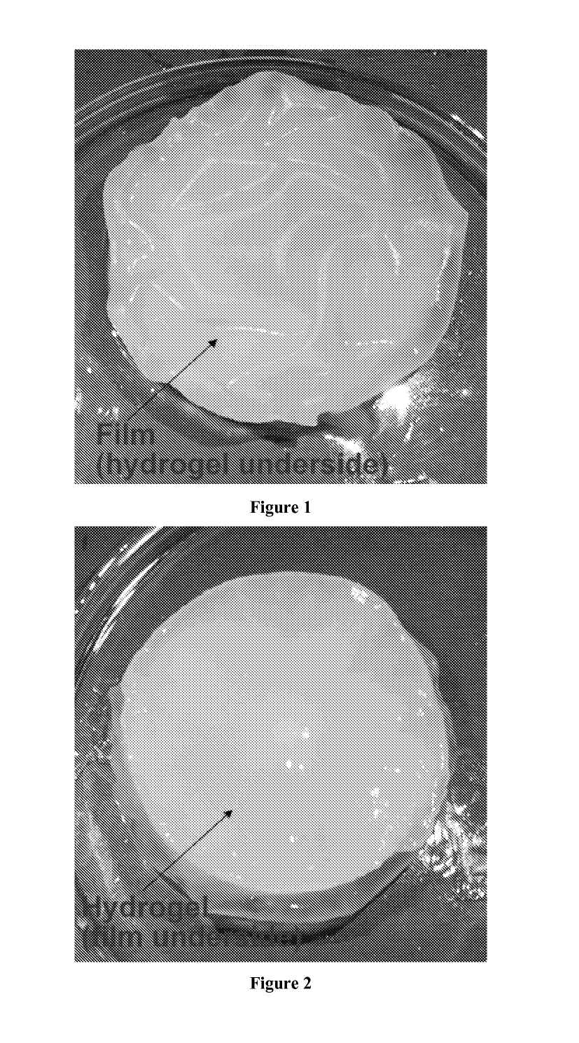

The dried PVA/PAA film was placed in a beaker and the aqueous solution containing PVA/NaOH/H₂O was added. This beaker was placed in a trough and approximately 500 mls of liquid nitrogen was added to the trough over a period of ten minutes. The solidified solution was allowed to thaw at room temperature for 24 hours resulting in a composite of hydrogel and film. FIG. 1 shows a picture of the film aspect of the composite, while FIG. 2 shows a picture of the hydrogel aspect of the composite.

### Optical Microscopy

Optical analysis was carried out on samples to examine the interface created. An ‘Olympus BX60 ’ microscope with a magnification of 10× was used to characterise the coating at a microscopic level.

### Modulated Differential Scanning Calorimetry

Modulated Differential scanning calorimetry (DSC) was performed using a DSC 2920 MDSC from TA instruments on samples that had been dried under atmospheric conditions for a minimum of 7 days. The dried samples contained negligible amounts of water. A sample of between 10 and 11 mg was tested in sealed aluminium pans. The samples were cooled to 25° C., the modulation was +/−1.00° C. every 60 seconds and the temperature was ramped from 25° C. to 285° C. and then ramped down to 25° C.

### Dissolution Studies

Dissolution testing was evaluated using a Sotax AT7 smart dissolution system from Carl Stuart Ltd. The standard solution contained 0.02 g of TH in 600 ml. The hydrogels were cut into discs and tested in a phosphate buffer of pH 7.2 at 37° C. The stir rate was set to 50 rpm with 900 ml of dissolution media used per vessel. Samples were automatically taken every 15 min and analysed by ultraviolet (UV) light at 276 nm using a 1 cm quartz cuvette on a Perkin-Elmer lambda 2 spectrometer. The dissolution profile was observed from a plot of time versus absorbance.

### Micro Thermal Analysis

Micro thermal analysis was conducted using a Topometrix A 2990 micro-thermal analyzer, which combines an atomic force microscope with a Wollaston type temperature controlled thermal probe. Characterisation was carried out in two modes: micro-modulated thermal analysis (μMDTA), in which thermal transitions are measured, and micro-thermo mechanical analysis (μTMA), in which expansion, softening, melting and glass transitions are measured.

All measurements were performed in air. Topography and conductivity images were obtained by scanning the probe over the surface while maintaining it at a constant temperature. As the probe scanned across the sample surface two images were obtained; (1) surface topography and (2) thermal conductivity. Local thermal analysis (LTA) was performed by positioning the tip at a selected location and subsequently heating, resulting in a sensor (μTMA) and a power signal (μDSC).

The calibration of the sensor was verified using PET of known melting point. A performance check was carried out on a semi-conductor silicon grid, which consisted of raised silicon squares with a 3 μm pitch. This determined whether the system was fully operational. Micro thermal analysis of the samples were performed on samples of 4×4 mm² and fixed onto metallic sample stubs using double sided sticky tape. These samples were cut from the gel and exposed to atmospheric conditions for 7 days to ensure that minimum moisture was present. Images of 50×50 μm² were recorded at a scan speed of 20 μms.

In each sample three locations were selected for analysis by LTA. The probe was heated from 0° C. to 350° C. at a heating rate of 20° C./s using a contact force corresponding to 10 nA (1 nA corresponds to 3-4 nN). 150 points per second were recorded using a frequency of 2.2 KHz and a heating amplitude of 3° C. Analysis was carried out on twenty different locations and representative results are displayed.

### Results

### Optical Microscopy

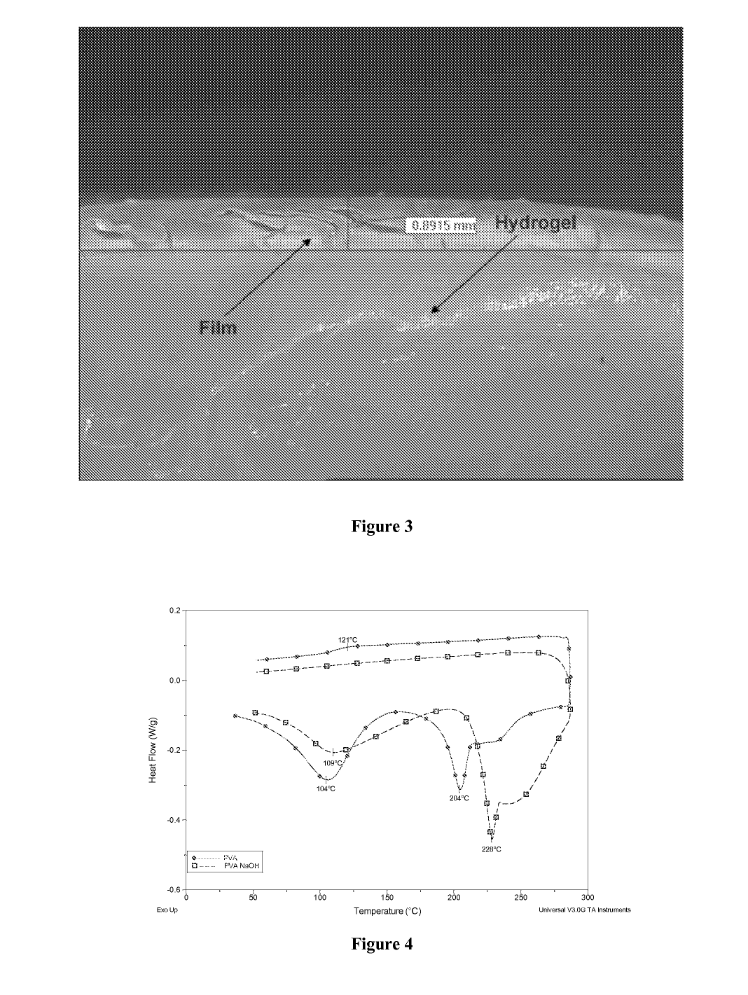

A viable composite with sufficient integrity, was formed with the addition of NaOH to PVA. Adhesion may be caused by interdiffusion of polymer chains across the interface. This interdiffusion leads to entanglements and physical bonds between the PVA/PAA and the PVA/NaOH/H₂O. The level of penetration of the polymer chains ends is a function of the polymers and the contact time between the two substances. By using a PVA/NaOH/H₂O gel and the correct thickness of layer a viable composite with biomedical potential was produced. FIG. 3 shows a detailed photo of the interface of the film (support layer) and gel. The hydrogel and the film have formed a cohesive structure. The PVA/PAA film maintained its integrity, even though it has become imbibed with water. The film gives the composite structural integrity while the hydrogel provides a reservoir for active agents.

### Modulated Differential Scanning Calorimetry

PVA exhibits transitions at 85° C., 143° C. and a large peak above 210° C. The peak at 85° C. known as the α relaxation, represents the glass transition temperature of PVA. The relaxation observed at 143° C., designated as the β relaxation, is due to the relaxation in the PVA crystalline domains. The third relaxation, which occurs at a temperature between 200° C. and 260° C., is caused by the melting of the crystalline domains of PVA. Crystallinity increases with the addition of certain concentrations of NaOH for PVA hydrogels.

The melting temperature of TH is 270° C. When placed in contact with water at ambient temperature, anhydrous TH is known to transform to TH monohydrate. Upon drying of TH, Phadnis et al. (Phadnis N. V, Suryanarayanan R. Polymorphism in anhydrous theophylline implications on the dissolution rate of theophylline tablets. Journal of pharmaceutical sciences 1997; 86: 1256-1263) postulated that a transition in the region of 145° C. could be attributed to the solid to solid transition of a metastable anhydrous TH.

FIG. 4 shows the thermograms of the samples without any TH present. The melting point of PVA is at 205° C. The addition of NaOH results in an increase in the melting point of PVA to 228° C. and is consistent with previous work. The endotherm present in the region of 92° C. for the samples is due to the evaporation of residual water. Upon cooling there is only one endotherm present for PVA, at 121° C. which may be due to the β relaxation.

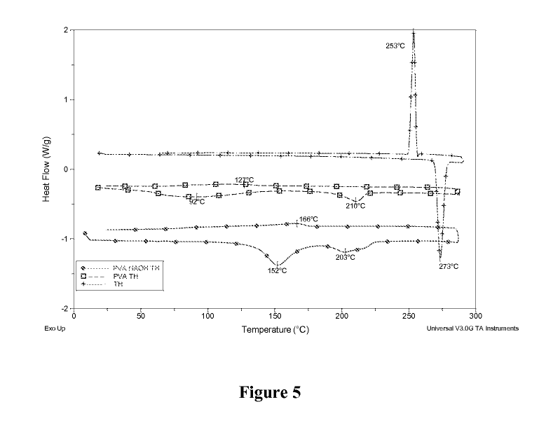

FIG. 5 shows the thermograms of PVA/NaOH/TH and PVA/TH samples and TH on its own. The melting point of TH is 274° C. and it shows no other transitions, upon cooling there is a crystallization endotherm at 255° C. For the PVA/NaOH/TH sample, as the temperature is ramped up, a transition is shown at 152° C. and upon cooling another transition is present at 166° C. These transitions may be due to the solid to solid transition of a metastable anhydrous TH or the crystalline relaxation of PVA. It is interesting that this transition is not present in the PVA/NaOH samples with no TH and would indicate that TH is the cause. The addition of TH to PVA/NaOH results in a reduced melting point of 203° C., suggesting that TH interferes with the crystalline structure. The melting point of TH, in the PVA/NaOH/TH samples is masked and is not clearly visible. The melting point of the PVA/TH samples is essentially the same at 210° C. A transition is present upon cooling at 127° C. and is similar to the transition present in FIG. 4 and may be due to the crystalline relaxation of PVA or the transition of a metastable anhydrous.

PVA gels are believed to consist of crystalline regions consisting of junction zones and amorphous regions consisting of long flexible chains. The extent of crystallinity in a PVA hydrogel has an important effect on the mechanical properties of the gels. Gels with a high crystallinity have reduced elasticity and are fragile, whereas if the crystallinity is too low, gels are poorly coherent. In addition crystallinity has an effect on drug dissolution for TH, with inconsistent drug release. Mojii Adeyeye et al. (Moji Adeyeye C, Rowley J, Madu D, Javadi M, Sabnis S. S. Evaluation of crystallinity and drug release stability of directly compressed theophylline hydrophilic matrix tablets stored under varied moisture conditions, International Journal of Pharmaceutics 1995; 116: 65-75.) investigated TH drug delivery systems under varying humidity conditions and found that crystal changes occurred whereby the anhydrous TH changed to the monohydrate. The possibility of crystalline hydrate formation in TH and the PVA crystallisation process complicates the design of a consistent reproducible formulation process.

### Micro Thermal Analysis

Micro thermal analysis combines the imaging capabilities of atomic force microscopy with the ability to characterise the thermal behaviour of materials. It is an extension of scanning thermal microscopy which is part of the family of scanning probe microscopy techniques. The method of local thermal analysis measurements using a micro-thermal analyser is accurate, robust and fast. It is used to study a variety of applications, including drug formulations, polymer blends, interface behaviour in injection moulded components and thickness analysis of polymer films.

### Analysis of Relative Thermal Conductivity

In μTA, the surface can be visualised, according to its response to the input of heat. The thermal images obtained from the μTA are affected by the topography of the samples. As the probe travels over the sample, the current changes to maintain the probe at constant temperature. When the probe is at a higher peak, it is surrounded by less sample and more air. Air has a lower thermal conductivity than the sample and the apparent conductivity appears reduced. The thermal image approach, depends on the thermal conductivity between components being sufficiently high, to allow differentiation. It should be stated that differentiation between components using thermal conductivity is not completely reliable, with systems such as HPMC-Ibuprofen having no clear distinction between different particles.

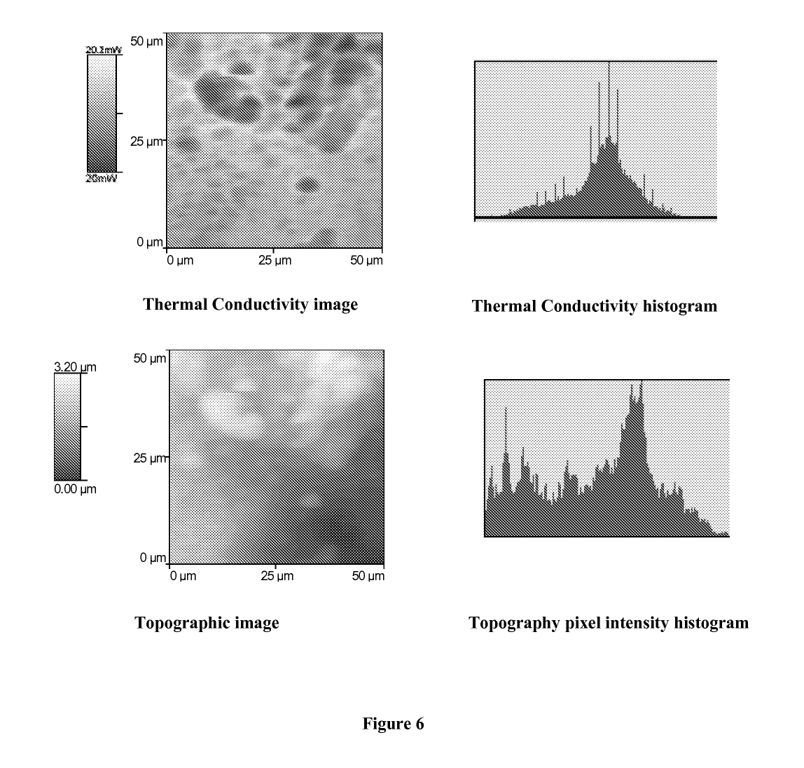

In order to explore the possibility of differentiating between the PVA and TH phases using thermal conductivity, 2 D topography and thermal conductivity images with corresponding pixel intensity histograms of PVA/TH, PVA, and PVA/NaOH were considered and presented in FIGS. 6,7 and 8.

Typical variations in thermal conductivity studies are between 0.01 to 0.04 mW. All samples show a relatively uniform conductivity, with slight variations due to the topography of the samples. Since in most cases the variations are superimposed on topographical features, it is difficult to resolve images definitively.

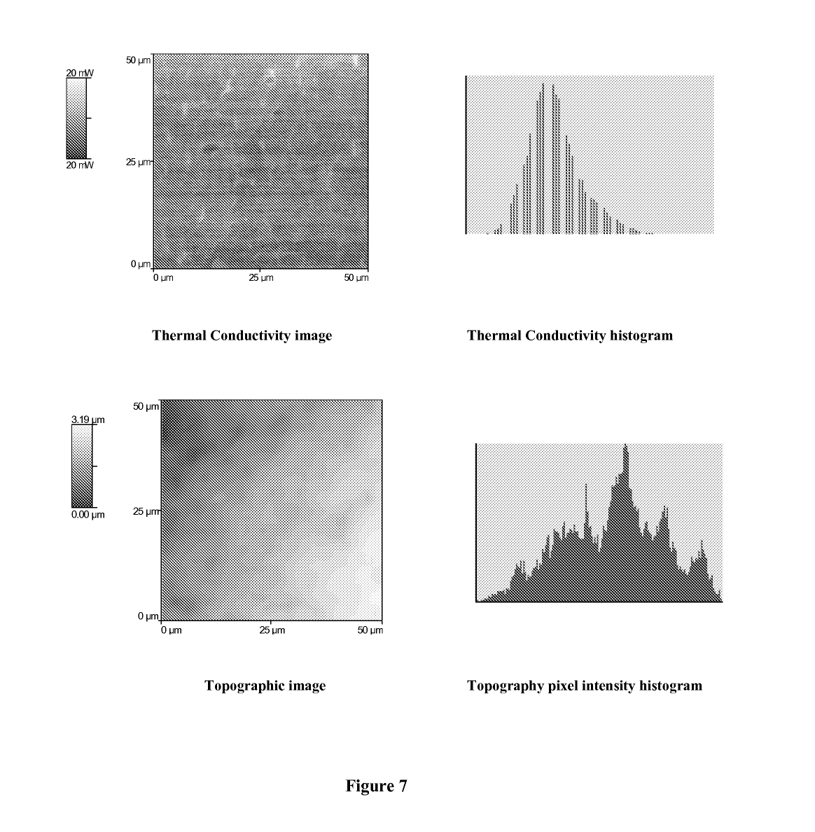

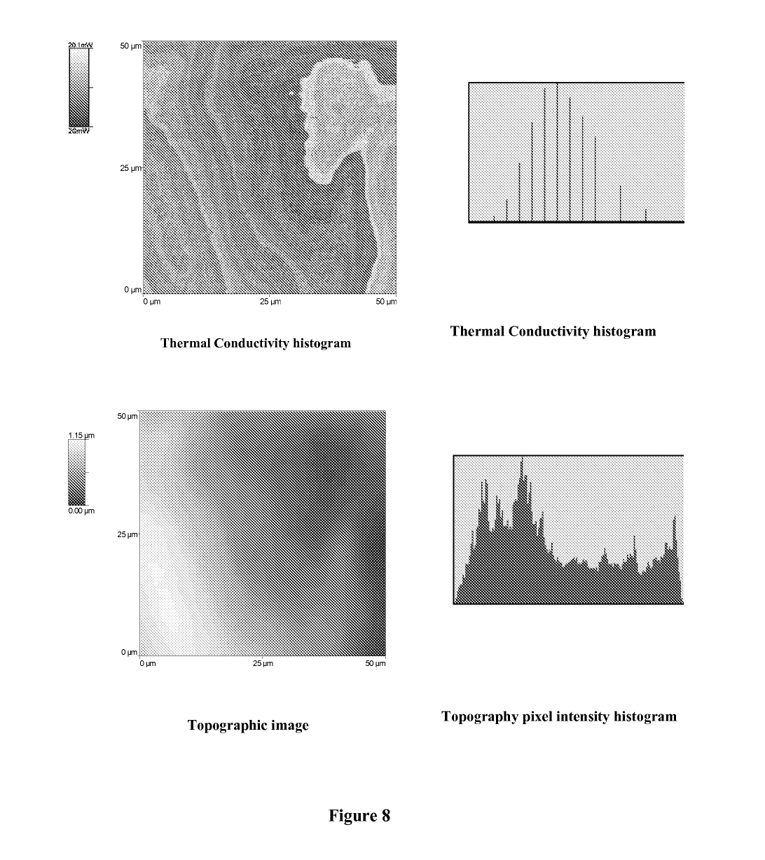

Makovic et al. (Markovic N, Agotonovic-Kustrin S, Glass B, Prestidge C. A. Physical and thermal characterisation of chiral omeprazole sodium salts. Journal of pharmaceutical and biomedical analysis 2006; 42: 25-31.) characterised chiral omperazole sodium salts and used images and intensity histograms of topography and thermal conductivity to differentiate between amorphous and microcrystalline phases and proposed that conductivity is not a simple reflection of topography. Using this histogram approach, all the images for thermal conductivity show a monomodal distribution, while the topography images all show a multimodal distribution. This suggests that there may be a slight systematic topographic difference in the height due to different phases present. The phase present in PVA/TH sample may be due to TH, amorphous PVA and crystalline PVA. The phases present in the PVA/NaOH and PVA samples may be due to amorphous and crystalline PVA. However the differences between FIGS. 6, 7 and 8 are small enough to suggest that there is a uniform distribution of the components, specifically the distribution of TH in PVA.

### Localised Thermal Analysis

Localised thermal analysis (LTA) is the process whereby, a thermal probe is placed at a selected point on the surface and the temperature ramped linearly with time. The power required to raise the temperature gives a calorimetry signal. In addition to calorimetry, the position of the cantilever is measured. When the probe is placed on the surface, the cantilever is bent to a predetermined extent ensuring a controlled force on the tip. As the temperature rises the sample will soften and tip deflection is measured. The change in deflection of the cantilever is measured concurrently with the localized calorimetry and allows a micro-thermomechanical analysis of the sample. Conventional DSC yields a specimen average response, as a relatively small sample is placed into a large heating container. Consequently the melting of a sample using μTA may not be directly comparable to DSC.

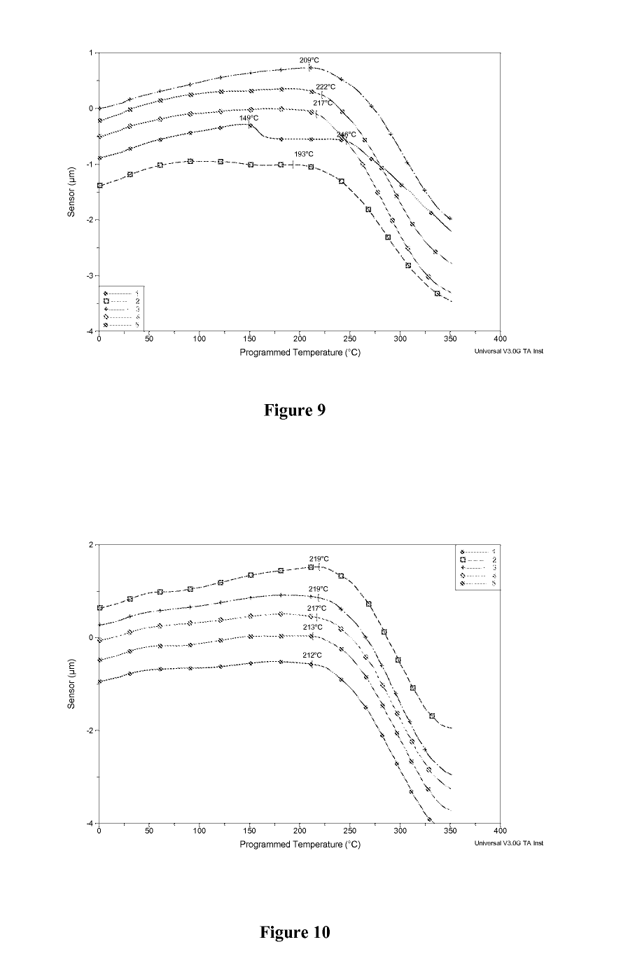

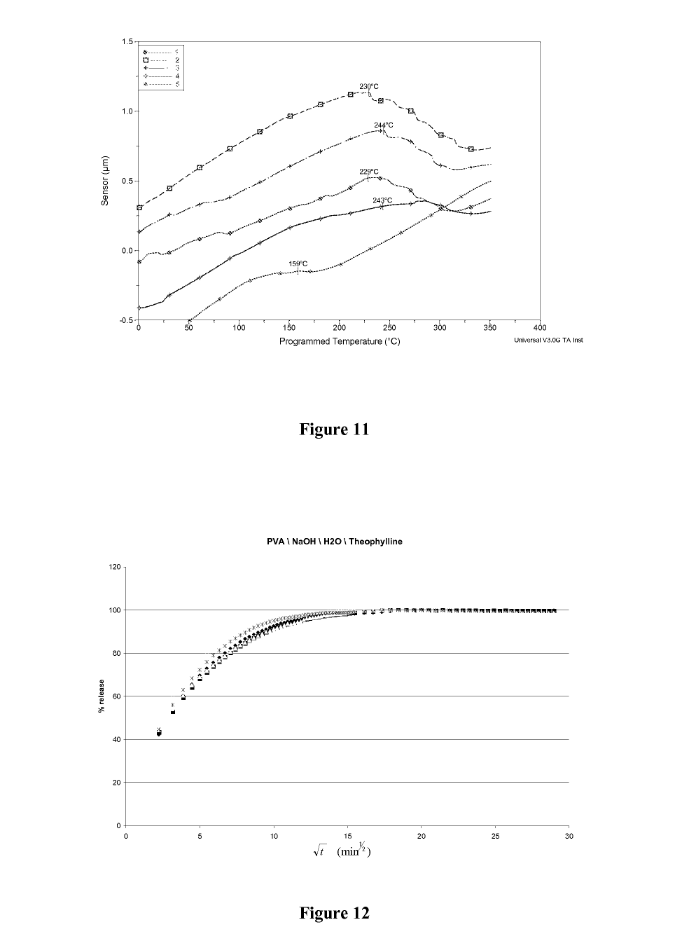

The results of a LTA measurement of frozen PVA in the presence and absence of TH are shown in FIGS. 9 and 10. The results of a LTA measurement of frozen PVA with NaOH are displayed in FIG. 11. Examining FIG. 9, the traces for PVA & TH (3,5,4 & 2) show a penetration at 209° C., 222° C., 217° C. and 193° C. respectively. The penetration of the probe into the material can be expected to occur, once most of the crystals are molten. This melting range agrees with literature and the DSC results. Trace 1 shows transitions at 149° C. and 246° C. The lower transition is probably caused by the β relaxation, which is a relaxation in the PVA crystalline domains observed at 143° C. alternatively, it may be due to the solid to solid transition of a metastable anhydrous TH.

The higher temperature transition of 246° C. could suggest the recrystallisation of TH, a similar transition was observed in the MDSC thermograms of TH on its own. For PVA in the absence of TH, as shown in FIG. 10, the melting of the crystalline regions occurs between 212° C. and 219° C. which is expected. Examining FIG. 11, the traces for the PVA/NaOH show that the penetration of the probe occurs with greater difficulty and at a higher temperature. The lowest softening point is 229° C. while the highest is 244° C. This indicates that the addition of NaOH has increased crystallinity and this will result in a stronger resistance to thermally or mechanically induced sliding motion of the chain. This would explain the high tip deflection of the probe. Trace 1 shows a transition at 159° C. which is probably due to the β relaxation.

### Theophylline Release Studies

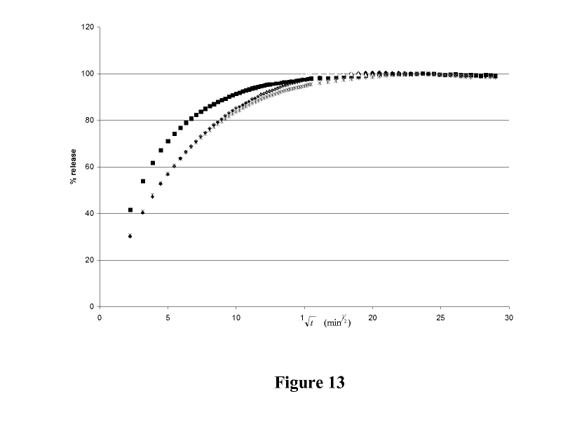

TH release was studied for a total of 840 minutes under specified conditions. When % release was plotted versus the square root of time, it showed a linear relationship between 5 and 60% indicating that TH release followed the Higuchi Matrix dissolution model. Release rates were calculated from FIGS. 12 and 13. These were 4.6 (% release/√min) for PVA/NaOH and 5.6 (% release/√min) for PVA on its own. The slower rate from PVA/NaOH is probably due to the increased crystallinity of PVA\NaOH sample, which retards the release of the drug. In crystalline materials such as TH, hydrogen bonding is relatively weak, though it has been reported that there was a decrease in drug release from TH microcrystalline cellulose pellets prepared by wet granulation due to the formation of additional binding of TH and the microcrystalline cellulose.

### Diffusion Exponent

Peppas (Peppas N. A. Analysis of Fickian and non-Fickian drug release from polymers, Pharm. Acta Helv. 1985; 60: 110-111.) presented a simple semi-empirical equation, which can be used to analyse data of controlled release of water soluble drugs from polymers. The general form of the equation is:

$$\frac{{M}_{t}}{{M}_{∞}} = {kt}^{n} \qquad ( 1 )$$

where Mₜ/M_{∞} is the fractional release, k is the kinetic constant and n is the diffusion exponent. When log Mₜ/M_{∞} is plotted against log t, the value of the diffusion exponent was obtained. These were 0.29 and 0.33 for PVA/NaOH/H₂O and PVA/H₂O respectively. These values are near the Fickian exponent value of n=0.45 discussed by Peppas. Thus TH release was controlled by a pure diffusion mechanism. Shaheen et al. (Shaheen S. M, Yamaura K. Preparation of theophylline hydrogels of atactic poly(vinyl alcohol)/NaCl/H₂O system for drug delivery. Journal of Controlled Release 2002; 81:367-377; Shaheen S. M, Ukai K, Dai L, Yamaura K. Properties of atactic poly(vinyl alcohol)/NaCl/H₂O system and their application for drug delivery. Polymer International 2002; 51:1390-397.) discussed the use of PVA/NaCl/H₂O systems for the delivery of TH. The drug release behaviour showed an irregular Fickian diffusion which broadly, corresponds to our results.

Hickey and Peppas (Hickey A. S, Peppas N. A, Mesh size and diffusion characteristics of semi-crystalline PVA membranes prepared by freezing thawing techniques. J. Membr. Sci. 1995; 107:229-237.) in the investigation of drug release from PVA found that repeated freezing/thawing cycles led to a denser crystalline structure with the changes in crystallinity having little effect on the mechanism of release. However the formation of salts or crystalline ionic complexes is a well established as altering the physicochemical properties of an active pharmaceutical ingredient, with the inherent drawback of reduced control. TH forms a monohydrate in the presence of water and additional interactions may occur between TH and the PVA. The relatively fast release may be attributed to the high water content of the hydrogel (>90%). To achieve sustained release which is independent of the drug molecular weight, compounds may be entrapped in second phase which is incorporated into the hydrogel.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A composite article comprising:
(i) gel having absorbed solvent therein;
(ii) a support layer attached to the gel,
the composite article having being formed by providing a gel-forming solution comprising a polymeric material and a solvent; and attaching the gel to the support layer by forming the gel on the support layer after a part of the support layer is solubilised by the solvent.

2. A composite according to claim 1 wherein the support layer is solubilised at an elevated temperature.

3. A composite according to claim 1 wherein the support layer wherein the solubilisation of the support layer is halted by freezing.

4. A composite according to claim 1 wherein the gel is a hydrogel.

5. A composite according to claim 1 wherein the gel is based on polyvinyl alcohol.

6. A composite according to claim 1 wherein the support layer comprises polyvinyl alcohol.

7. A composite according to claim 1 wherein the support layer comprises polyacrylic acid.

8. A composite according to claim 5 wherein the support layer comprises polyacrylic acid.

9. A composite according to claim 1 further comprising an active agent.

10. A process for forming a composite article comprising the steps of:
(i) providing a gel-forming solution comprising a polymeric material and a solvent;
(ii) providing a support layer for the gel, the support layer being at least partially soluble in the solvent; and
(iii) attaching the gel to the support layer by forming the gel on the support layer after a part of the support layer is solubilised by the solvent.

11. A process according to claim 10 wherein the support layer is solubilised at an elevated temperature.

12. A process according to claim 10 wherein the support layer wherein the solubilisation of the support layer is halted by freezing.

13. An assembly comprising a substrate having applied thereto a composite article comprising:
(i) gel having absorbed solvent therein;
(ii) a support layer attached to the gel,
the composite article having being formed by providing a gel-forming solution comprising a polymeric material and a solvent; and attaching the gel to the support layer by forming the gel on the support layer after a part of the support layer is solubilised by the solvent.

14. An assembly according to claim 13 wherein the substrate is a flexible material and the assembly forms a medical dressing.

15. An assembly according to claim 13 wherein the substrate is a medical device and the composite forms a coating for the medical device.

16. An assembly according to claim 15 wherein the medical device is selected from the group consisting of a device introduced into the body or a device implanted in the body.
